(19) United States
(12) Patent Application Publication
(10) Pub. No.: US 2024/0378822 A1
(43) Pub. Date: Nov. 14, 2024

(54) RENDERING VIRTUAL CONTENT WITH IMAGE SIGNAL PROCESSING TONEMAPPING

(71) Applicant: Apple Inc., Cupertino, CA (US)

(72) Inventors: Tobias Holl, Sunnyvale, CA (US); Seyedkoosha Mirhosseini, Santa Clara, CA (US); David M. Cook, Broomfield, CO (US)

(21) Appl. No.: 18/658,039

(22) Filed: May 8, 2024

Related U.S. Application Data
(60) Provisional application No. 63/465,294, filed on May 10, 2023.

(51) Int. Cl. G06T 19/00; G06T 3/40; G06T 5/92; G06V 10/60

(52) U.S. Cl. CPC G06T 19/006; G06T 3/40; G06T 5/92; G06V 10/60

(57) ABSTRACT

Various implementations disclosed herein include devices, systems, and methods that adjust a tone map used to display virtual content in an extended reality (XR) environment based a tone map of pass-through video. For example, a process may obtain virtual content associated with a virtual content tone map relating pixel luminance values to display space luminance values. The process further obtains pass-through video depicting a physical environment. The pass-through video is associated with an image signal processing (ISP) tone map relating pixel luminance values of the pass-through video signal to display space luminance values. The process further determines an adjustment adjusting the virtual content tone map based on the ISP tone map. The process further displays a view of an XR environment. The view includes the pass-through video displayed using the ISP tone map and the virtual content displayed using the virtual content tone map with the adjustment.

### CROSS-REFERENCE TO RELATED APPLICATIONS

This application claims the benefit of U.S. Provisional Application Ser. No. 63/465,294 filed May 10, 2023, which is incorporated herein in its entirety.

### TECHNICAL FIELD

The present disclosure generally relates to systems, methods, and devices that adjust a tone map used to display virtual content in a pass-through extended reality (XR) environment based a tone map of pass-through video.

### BACKGROUND

Existing XR environment presentation techniques, enable viewing of virtual and passthrough video content. Existing XR environment presentation techniques may not adequately account for lighting of virtual content with respect to passthrough video content.

### SUMMARY

Various implementations disclosed herein include devices, systems, and methods that adjust a virtual content tone map (e.g., a filmic tone map) used to display virtual content in a pass-through XR environment based an image signal processing (ISP) tone map associated with pass-through video content. For example, a tone map used to display the virtual content may be adjusted to match an ISP tone map such that virtual content is more consistent in appearance (e.g., with respect to lighting, color, reflections, etc.) with (real) pass-through content (e.g., a realistic appearance, a natural appearance, etc.).

In some implementations, a virtual content tone map may relate pixel luminance values of virtual content to display space luminance values. In some implementations, an ISP tone map may provide boost to or suppress pixel luminance values with respect to linear luminance values (e.g., crunching bright values). In some implementations, a virtual content tone map may be updated over time (e.g., every frame) during ISP tone map changes such as while a user looks around to lighter or darker portions of an XR environment, etc.

In some implementations, an XR environment may include pass-through content as well as virtual content. The virtual content tone map may include a portion (e.g., an extended dynamic range (EDR) portion) that is not included within an ISP tone map (e.g., a standard dynamic range (SDR) map) that may be additionally adjusted. For example, an extrapolation technique may be used to adjust the portion.

In some implementations, virtual content may be adjusted (e.g., rescaled) based on an exposure of an image sensor such as a camera. For example, a brightest pixels exposure may be used as a reference value for rescaling the virtual content.

In some implementations, an electronic device has a processor (e.g., one or more processors) that executes instructions stored in a non-transitory computer-readable medium to perform a method. The method performs one or more steps or processes. In some implementations, the electronic device obtains virtual content. The virtual content may be associated with a virtual content tone map that relates pixel luminance values of the virtual content to display space luminance values. In some implementations, a pass-through video signal is obtained from an image sensor of one or more sensors of the electronic device. The pass-through video signal may include pass-through video depicting a physical environment. The pass-through video may be associated with an ISP tone map relating pixel luminance values of the pass-through video signal to display space luminance values. In some implementations, an adjustment may be determined for adjusting at least a portion of the virtual content tone map based on the ISP tone map. In some implementations, a view of an extended reality (XR) environment may be displayed. The view may include the pass-through video displayed using the ISP tone map and the virtual content displayed using the virtual content tone map with the adjustment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIG. 2A illustrates a graphical representation comprising a virtual content tone map plotted with respect to an ISP tone map, in accordance with some implementations

FIG. 2B illustrates a graphical representation representing a virtual content tone map mapping pixel luminance to an SDR display range and a virtual content tone map mapping pixel luminance to an EDR display range, in accordance with some implementations.

FIGS. 3A-3C illustrate views of an XR environment at different instants in time, in accordance with some implementations.

FIG. 4 is a flowchart illustrating an exemplary method that adjusts a virtual content tone map used to display virtual content in a pass-through extended reality (XR) environment based a tone map of pass-through video, in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

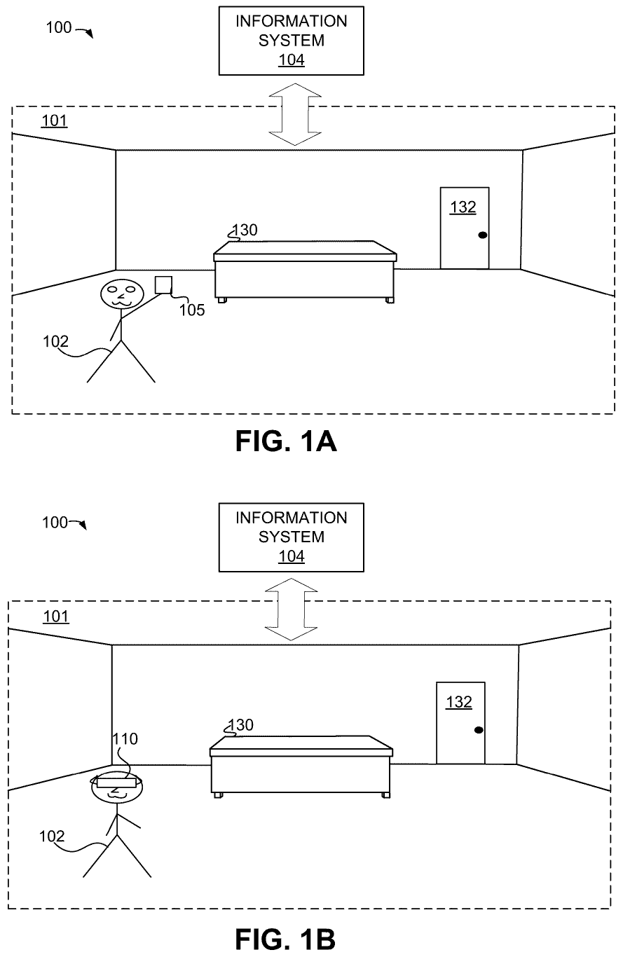

FIGS. 1A-B illustrate an example environment 100 including exemplary electronic devices 105 and 110 operating in a physical environment 101. Additionally, example environment 100 includes an information system 104 (e.g., a device control framework or network) in communication with electronic devices 105 and 110. In the example of FIGS. 1A-B, the physical environment 101 is a room that includes a desk 130 and a door 132. The electronic devices 105 and 110 may include one or more cameras, microphones, depth sensors, or other sensors that can be used to capture information about and evaluate the physical environment 101 and the objects within it, as well as information about the user 102 of electronic devices 105 and 110. The information about the physical environment 100 and/or user 102 may be used to provide visual and audio content (e.g., associated with the user 102) and/or to identify the current location of the physical environment 100 and/or the location of the user within the physical environment 100. In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include pass-through video of the physical environment 100. Such an XR environment may include virtual content that is positioned at 3D locations relative to a 3D coordinate system associated with the XR environment, which may correspond to a 3D coordinate system of the physical environment 100.

In some implementations, virtual content and a pass-through video signal (depicting a physical environment) are retrieved via a wearable device such as, inter alia, a head mounted device (HMD). The virtual content may be associated with a virtual content tone map (e.g., a filmic tone map/curve) relating pixel luminance values of the virtual content to display space luminance values (e.g., a filmic tone curve may emulate the luminance response to physical film, preserving dark colors-keeping black truly black—with little or no boosting relative to linear luminance values). The pass-through video signal may include pass-through video associated with an image signal processing (ISP) tone map (e.g., a curve) relating pixel luminance values of the pass-through video signal to display space luminance values.

In some implementations, a portion of the virtual content tone map may be adjusted based on the ISP tone map. For example, mapping values (of the virtual content tone map and the ISP tone map) may be aligned to be consistent with each other resulting in a virtual content tone map matching the ISP tone map for a portion (e.g., an SDR portion) of a range. An alignment process may include matching midpoint values of the mapping values. Alternatively, an HDR portion of a virtual content tone map may be adjusted, for example, by extrapolating an ISP tone map into an HDR range based on slope, etc.

In some implementations, a view of an XR environment is displayed. The view may include pass-through video displayed using the ISP tone map and virtual content displayed using an adjusted version of the virtual content tone map.

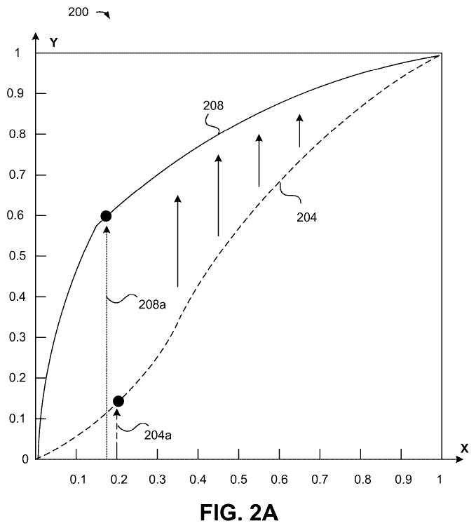

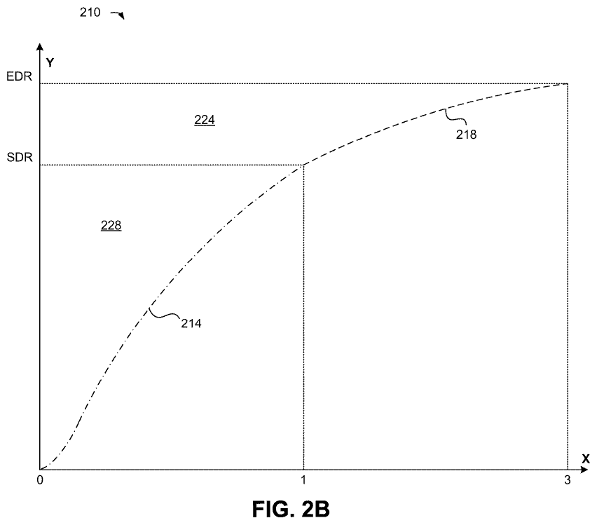

FIG. 2A is a graphical representation 200 illustrating a virtual content tone map 204 (comprising linear values such as linear value 204a) plotted with respect to an ISP tone map 208 (comprising linear values such as linear value 208a). Values on the X-axis represent pixel luminance values. Values on the Y-axis represent display space luminance values. In some implementations, an image sensor (e.g., a camera) retrieves sensor data that includes a luminance/color of a captured scene for display. In response, an associated tone map (i.e., ISP tone map 208) is applied to the sensor data enabling an ISP to maintain highlights associated with lighting attributes such that, for example, bright lights are not clipped away. In response, images captured by the image sensor (with respect to the ISP) are underexposed and ISP tone map 208 is applied to shift luminance values. Therefore, dark luminance values with respect to a center level are boosted and very bright luminance values are crunched. For example, a bright linear center value of 0.8 (of the pixel luminance values) maps to a value of 0.9 (of the display space luminance values) with respect to a final XR display.

In some implementations, ISP tone map 208 (i.e., associated with an image sensor retrieving pass-through video) changes with respect to every frame of the pass-through video. In some implementations, values of ISP tone map 208 are mapped (e.g., with respect to midpoint values) with values of virtual content tone map 204 such that a portion of virtual content tone map 204 is matched to a portion of ISP tone map 208 (e.g., an SDR portion) with respect to a specified range thereby enabling a view of an XR environment to be displayed. The view may include pass-through video being displayed using ISP tone map 208 and virtual content being displayed using an adjusted version of the virtual content tone map 204. In some implementations, the virtual content tone map 204 may be periodically updated with respect to ISP tone map modifications occurring while a user is viewing bright or dark portions (e.g., a light in a room has been turned on or turned off) of pass-through video. In some implementations, periodically updating the virtual content tone map 204 is performed with respect to every frame of the pass-through video.

In some implementations, an additional portion of the virtual content tone map 204 (comprising a range differing from a range represented in the ISP tone map 208) is adjusted such that a modified view of virtual content is displayed. For example, the additional portion of the virtual content tone map 204 may be an (EDR) portion and the ISP tone map 208 may be an SDR tone map (e.g., the virtual content is displayed with a color or tone matching or is associated with a color or tone of passthrough video).

In some implementations, the virtual content pixel luminance is adjusted based on exposure values of an image sensor before applying the virtual content tone map such that a modified view of virtual content is displayed (e.g., the virtual content is displayed with a color or tone matching or associated with a color or tone of passthrough video). In some implementations, the virtual content pixel luminance values are adjusted based on a rescaling adjustment. In some implementations, the exposure values are associated with a brightest pixel being used as a reference value for the rescaling adjustment.

The aforementioned mapping process enables ISP functionality to determine a specified tone map (e.g., ISP tone map 208) for application to passthrough video of an image sensor such as a camera thereby enabling ISP tone map 208 to be applied to virtual content. The mapping process may result in virtual content being in modified to be more consistent in appearance (e.g., with respect to lighting, color, reflections, etc.) with (real) pass-through content (e.g., a realistic appearance, a natural appearance, etc.).

FIG. 2B illustrates a graphical representation 210 representing a virtual content tone map portion 214 within an SDR range 228 and a virtual content tone map portion 218 within an EDR range 224. Representation 210 enables virtual content tone map portion 214 to be adjusted based on an ISP tone map and virtual content tone map portion 218 to be adjusted based on extending the ISP tone map into EDR range 224.

In some implementations, virtual content tone map portion 218 may be extrapolated by extending an ISP tone map within the EDR range 224. For example, a midpoint of an initial virtual content tone map may be selected for selecting an extension portion to extend from an ISP tone map in a similar manner. Alternatively, virtual content tone map portion 218 may be extrapolated by extending an ISP tone map into the EDR range 224 based on a determined slope.

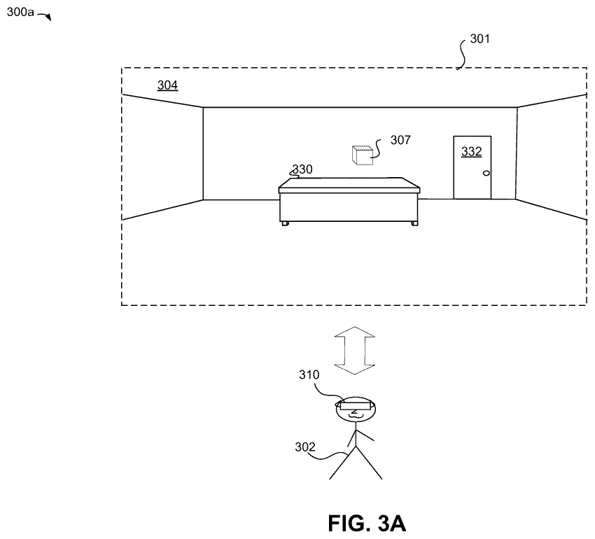

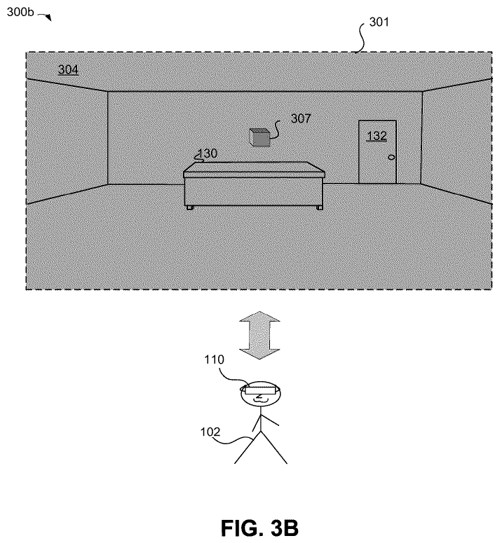

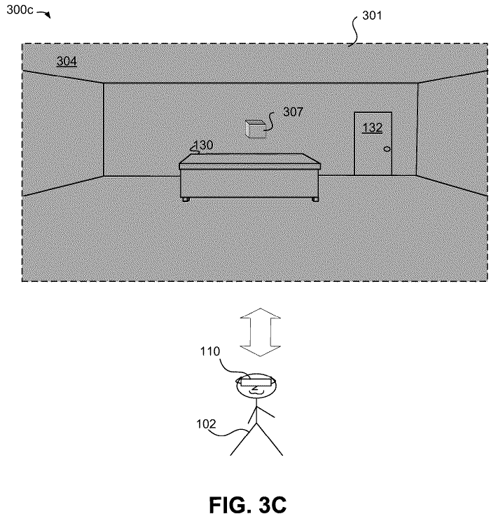

FIGS. 3A-3C illustrate views of an XR environment 301 at different instants in time. The views (e.g., view 300a, view 300b, and view 300c) are provided for a user 302 via an electronic device 310 (e.g., an HMD). XR environment 301 comprises a physical environment 304 and a virtual object 307. In the example of FIGS. 3A-3C, the physical environment 304 is a room that includes a desk 330 and a door 332.

In the example of FIG. 3A, at a first instant in time corresponding to view 300a, a pass-through video image/stream representing physical environment 304 (of XR environment 301) is presented (to user 302 via electronic device 310) with a significant amount of ambient lighting (e.g., ceiling lights, a lamp, etc. have been turned on) such that virtual object 307 (of XR environment 301) is consistent in appearance (e.g., with respect to the lighting, color, reflections, etc.) with respect to physical environment 304 (e.g., a realistic appearance, a natural appearance, etc.).

In the example of FIG. 3B, at a second instant in time corresponding to view 300b, a pass-through video image/stream representing physical environment 304 (of XR environment 301) is presented (to user 302 via electronic device 310) with less lighting (e.g., ceiling lights, a lamp, etc. have been turned off). View 300b is presented subsequent to an adjustment of a lighting/color of virtual object 307 based on an amount of lighting (provided via pass-through video in XR environment 304) such that virtual object 307 (of XR environment 301) may be matched or mismatched (e.g., too dark) with respect to the pass-through video. The mismatch may occur in response to using an exposure of a camera as a light detection sensor to determine an amount of lighting within the physical environment 304. The amount of lighting is used to adjust a lighting for virtual content (e.g., virtual object 307). For example, an exposure value of a camera may be applied to a texture to specify lighting attributes.

In the example of FIG. 3C, at a third instant in time corresponding to view 300c, a pass-through video image/stream representing physical environment 304 (of XR environment 301) is presented (to user 302 via electronic device 310) subsequent to adjustment of a virtual content tone map (based on an ISP tone map) and detection of an amount of lighting (via usage of an exposure of a camera as a light detection sensor as described with respect to FIG. 3B) provided by pass-through video in XR environment 304. The aforementioned adjustment of the virtual content tone map in combination with detected amount of lighting is used to modify (e.g., with respect to lighting or contrast) display of virtual content (with respect to lighting of pass-through video in XR environment 304) based an ISP tone map of the pass-through video. An adjustment of a virtual content tone map used to display virtual content may enable display of virtual object 307 to be consistent in appearance (e.g., virtual object 307 has been presented with a viewable color/brightness that provides a realistic or natural appearance) with respect to physical environment 304. For example, a virtual content tone map used to display the virtual content may be adjusted to match an ISP tone map such that virtual content is more consistent in appearance (e.g., with respect to lighting, color, reflections, etc.) with (real) pass-through content (e.g., a realistic appearance, a natural appearance, etc.).

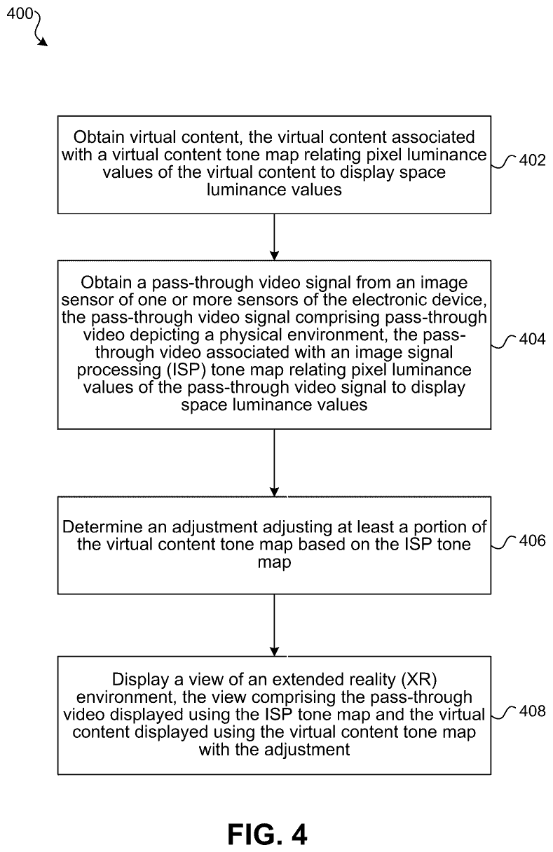

FIG. 4 is a flowchart representation of an exemplary method 400 that enables a virtual tone map used to display virtual content in a pass-through extended reality (XR) environment to be adjusted based a tone map of pass-through video, in accordance with some implementations. In some implementations, the method 400 is performed by a device, such as a mobile device (e.g., device 105 of FIG. 1A), desktop, laptop, HMD, or server device. In some implementations, the device has a screen for displaying images and/or a screen for viewing stereoscopic images such as a head-mounted display (HMD such as e.g., device 110 of FIG. 1B). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 obtains virtual content. In some implementations, the virtual content is associated with a virtual content tone map (e.g., a filmic tone map/curve) relating pixel luminance values of the virtual content to display space luminance values.

At block 404, the method 400 obtains a pass-through video signal from an image sensor such as a camera. In some implementations, the pass-through video signal includes pass-through video depicting a physical environment. In some implementations, the pass-through video may be associated with an image signal processing (ISP) tone map (e.g., curve) relating pixel luminance values of the pass-through video signal to display space luminance values. In some implementations, the ISP tone map is periodically updated with respect to ISP tone map modifications occurring while a user is viewing bright or dark portions of the pass-through video. In some implementations, periodically updating the ISP tone map occurs during every frame of the pass-through video. In some implementations, the image sensor is an outward facing camera of an electronic device such as, inter alia, an HMD.

At block 406, the method 400 determines an adjustment for adjusting a portion of the virtual content tone map based on the ISP tone map. In some implementations, adjusting the portion of the virtual content may include aligning mapping values of the portion of the virtual content tone map with respect to mapping values of the ISP tone map such that the virtual content tone map matches the ISP tone map for at least a portion (e.g., the SDR portion) of a tone range. In some implementations, aligning the mapping values may include matching midpoint values of the mapping values of the portion of the virtual content tone map with respect to midpoint values of the mapping values of the ISP tone map.

At block 408, the method 400 displays a view of an extended reality (XR) environment. The view of the XR environment may include the pass-through video displayed using the ISP tone map and the virtual content displayed using an adjusted version of the virtual content tone map.

In some implementations, the method 400 determines a second adjustment for adjusting a second portion of the virtual content tone map comprising a range differing from a range represented in the ISP tone map. The view of the XR environment may further include the virtual content displayed using the virtual content tone map with the second adjustment. In some implementations, the second portion may include an extended dynamic range (EDR) portion and the ISP tone map may include a standard dynamic range (SDR) tone map. In some implementations, the second adjustment may include using an extrapolation technique.

In some implementations, the method 400 determines a second alternative adjustment for adjusting a pixel luminance of the virtual content based on exposure values of the image sensor before applying the virtual content tone map such that a modified view of virtual content is displayed. In some implementations, the second alternative adjustment includes a rescaling adjustment. In some implementations, the exposure values may include a brightest pixel being used as a reference value for the rescaling adjustment.

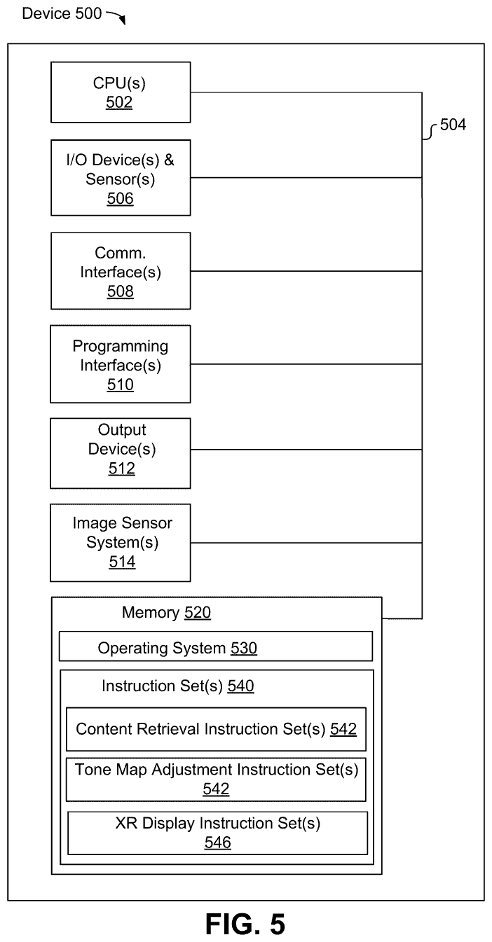

FIG. 5 is a block diagram of an example device 500. Device 500 illustrates an exemplary device configuration for electronic devices 105 and 110 of FIGS. 1A and 1B. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 504, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a content retrieval instruction set 542, a tone map adjustment instruction set 544, and an XR display instruction set 548. The instruction set(s) 540 may be embodied as a single software executable or multiple software executables.

The content retrieval instruction set 542 is configured with instructions executable by a processor to obtain virtual content associated with a virtual content tone map pass-through video associated with an ISP tone map.

The tone map adjustment instruction set 544 is configured with instructions executable by a processor to determine an adjustment for adjusting a portion of the virtual content tone map based on the ISP tone map.

The XR display instruction set 546 is configured with instructions executable by a processor to display a view (of an extended reality (XR) environment) that includes pass-through video displayed using an ISP tone map and virtual content displayed using an adjusted virtual content tone map.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described.

Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor and one or more sensors:
obtaining virtual content, the virtual content associated with a virtual content tone map relating pixel luminance values of the virtual content to display space luminance values;
obtaining a pass-through video signal from an image sensor of the one or more sensors, the pass-through video signal comprising pass-through video depicting a physical environment, the pass-through video associated with an image signal processing (ISP) tone map relating pixel luminance values of the pass-through video signal to display space luminance values;
determining an adjustment adjusting at least a portion of the virtual content tone map based on the ISP tone map; and
displaying a view of an extended reality (XR) environment, the view comprising the pass-through video displayed using the ISP tone map and the virtual content displayed using the virtual content tone map with the adjustment.

2. The method of claim 1, further comprising:
determining a second adjustment adjusting a second portion of the virtual content tone map comprising a range differing from a range represented in said ISP tone map, wherein the view further comprises the virtual content displayed using the virtual content tone map with the second adjustment.

3. The method of claim 2, wherein the second portion comprises an extended dynamic range (EDR) portion, and wherein the ISP tone map comprises a standard dynamic range (SDR) tone map.

4. The method of claim 3, wherein the second adjustment comprises using an extrapolation technique.

5. The method of claim 1, further comprising:
determining a second adjustment adjusting pixel luminance of the virtual content based on exposure values of the image sensor before applying the virtual content tone map such that a modified view of virtual content is displayed.

6. The method of claim 5, the second adjustment comprises a rescaling adjustment.

7. The method of claim 6, wherein the exposure values comprise a brightest pixel being used as a reference value for the rescaling adjustment.

8. The method of claim 1, wherein the virtual content tone map is a filmic tone map.

9. The method of claim 1, further comprising:
periodically updating the virtual content tone map with respect to ISP tone map modifications occurring while a user is viewing bright or dark portions of the pass-through video.

10. The method of claim 9, wherein said periodically updating occurs during every frame of the pass-through video.

11. The method of claim 1, wherein said adjusting comprises aligning mapping values of at least a portion of the virtual content tone map with respect to mapping values of the ISP tone map such that the virtual content tone map matches the ISP tone map for at least a portion of a tone range.

12. The method of claim 11, wherein said aligning comprises matching midpoint values of the mapping values of at least a portion of the virtual content tone map with respect to midpoint values of the mapping values of the ISP tone map.

13. The method of claim 1, wherein the image sensor is an outward facing camera of the electronic device.

14. The method of claim 1, wherein the electronic device is an HMD.

15. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining virtual content, the virtual content associated with a virtual content tone map relating pixel luminance values of the virtual content to display space luminance values;
obtaining a pass-through video signal from an image sensor of one or more sensors of the electronic device, the pass-through video signal comprising pass-through video depicting a physical environment, the pass-through video associated with an image signal processing (ISP) tone map relating pixel luminance values of the pass-through video signal to display space luminance values;
determining an adjustment adjusting at least a portion of the virtual content tone map based on the ISP tone map; and
displaying a view of an extended reality (XR) environment, the view comprising the pass-through video displayed using the ISP tone map and the virtual content displayed using the virtual content tone map with the adjustment.

16. The electronic device of claim 15, wherein the program instructions, when executed on the one or more processors, further cause the electronic device to perform operations comprising:
determining a second adjustment adjusting a second portion of the virtual content tone map comprising a range differing from a range represented in said ISP tone map, wherein the view further comprises the virtual content displayed using the virtual content tone map with the second adjustment.

17. The electronic device of claim 16, wherein the second portion comprises an extended dynamic range (EDR) portion, and wherein the ISP tone map comprises a standard dynamic range (SDR) tone map.

18. The electronic device of claim 17, wherein the second adjustment comprises using an extrapolation technique.

19. The electronic device of claim 15, wherein the program instructions, when executed on the one or more processors, further cause the electronic device to perform operations comprising:
determining a second adjustment adjusting pixel luminance of the virtual content based on exposure values of the image sensor before applying the virtual content tone map such that a modified view of virtual content is displayed.

20. A non-transitory computer-readable storage medium storing program instructions executable via one or more processors, of an electronic device, to perform operations comprising:
obtaining virtual content, the virtual content associated with a virtual content tone map relating pixel luminance values of the virtual content to display space luminance values;
obtaining a pass-through video signal from an image sensor of one or more sensors of the electronic device, the pass-through video signal comprising pass-through video depicting a physical environment, the pass-through video associated with an image signal processing (ISP) tone map relating pixel luminance values of the pass-through video signal to display space luminance values;
determining an adjustment adjusting at least a portion of the virtual content tone map based on the ISP tone map; and
displaying a view of an extended reality (XR) environment, the view comprising the pass-through video displayed using the ISP tone map and the virtual content displayed using the virtual content tone map with the adjustment.
